(19) United States
(12) Patent Application Publication
(10) Pub. No.: US 2002/0076646 A1
(43) Pub. Date: Jun. 20, 2002

(54) Optical information medium and its use

(75) Inventors: Guo-fu Zhou, Eindhoven (NL); Johannes Cornelis Norbertus Rijpers, Eindhoven (NL)

Correspondence Address: U.S. Philips Corporation, 580 White Plains Road, Tarrytown, NY, 10591, US

(73) Assignee: Koninklijke Philips Electronics N.V.

(21) Appl. No.: 10/011,886

(22) Filed: Dec. 4, 2001

(30) Foreign Application Priority Data
Dec. 15, 2000 (EP) 00204603.5

(51) Int. Cl. G11B 7/24

(52) U.S. Cl. 430/270.13; 430/945; 428/64.6; 369/275.2; 369/275.5

(57) ABSTRACT

An optical information medium (20) for high speed erasable recording by means of a laser-light beam (10) is provided. A substrate (1) has a stack (2) of layers with a first dielectric layer (5) and a second dielectric layer (7), a phase-change recording layer (6) between the first dielectric layer (5) and the second dielectric layer (7), and a reflective layer (3). The recording layer (6) has a compound of Ge and Te, and at least the first dielectric layer (5) consists of oxides of Ta and Si, nitrides of Si and Al, or carbides of Si, and is in contact with the recording layer (6). The recording layer (6) additionally may contain O or N in an amount up to 5 at. %. A broad usable composition range for low CET values is obtained. Thus high data rates are achieved.

The invention relates to an optical information medium for erasable recording by means of a laser-light beam having a laser-light wavelength, said medium having a substrate and a stack of layers provided thereon, the stack comprising a first dielectric layer and a second dielectric layer, a recording layer that is able to change between an amorphous and a crystalline state, arranged between the first dielectric layer and the second dielectric layer, and a reflective layer.

The invention also relates to the use of such an optical information medium for high-speed recording.

An optical information medium of the type described in the opening paragraph is known from an article by M. Chen, K.A. Rubin and R.W. Barton, published in Applied Physics Letters 49 (1986) 502.

An optical data storage medium based on the phase change principle is attractive, because it combines the possibilities of direct overwrite (DOW) and high storage density with easy compatibility with read-only optical data storage systems. Phase-change optical recording involves the formation of submicrometer-sized amorphous recording marks in a crystalline recording layer using a focused relatively high power laser-light beam. During recording of information, the medium is moved with respect to the focused laser-light beam that is modulated in accordance with the information to be recorded. Marks are formed when the high power laser-light beam melts the crystalline recording layer. When the laser-light beam is switched off and/or subsequently moved relatively to the recording layer, quenching of the molten marks takes place in the recording layer, leaving an amorphous information mark in the exposed areas of the recording layer that remains crystalline in the unexposed areas. Erasure of written amorphous marks is realized by recrystallization through heating with the same laser at a lower power level, without melting the recording layer. The amorphous marks represent the data bits, which can be read, e.g. via the substrate, by a relatively low-power focused laser-light beam. Reflection differences of the amorphous marks with respect to the crystalline recording layer bring about a modulated laser-light beam which is subsequently converted by a detector into a modulated photocurrent in accordance with the recorded information.

One of the most important demands in phase-change optical recording is a high data rate, which means that data can be written and rewritten in the medium with a rate of at least 30 Mbits/s. Such a high data rate requires the recording layer to have a high crystallization speed, i.e. a short crystallization time. To ensure that previously recorded amorphous marks can be recrystallized during direct overwrite, the recording layer must have a proper crystallization speed to match the velocity of the medium relative to the laser-light beam. If the crystallization speed is not high enough the amorphous marks from the previous recording, representing old data, cannot be completely erased, meaning recrystallized, during DOW. This causes a high noise level. A high crystallization speed is particularly required in high-density recording and high data rate optical recording media, such as in disc-shaped DVD+RW, DVR-red and blue which are abbreviations of a new generation high density Digital Versatile Disc+RW, where RW refers to the rewritability of such discs, and Digital Video Recording optical storage discs, where red and blue refer to the used laser wavelength. For these discs the complete erasure time (CET) has to be at most 60 ns. CET is defined as the minimum duration of an erasing pulse for complete crystallization of a written amorphous mark in a crystalline environment, which is measured statically. For DVD+RW, which has a 4.7 GB recording density per 120 mm disk, a data bit rate of 33 Mbits/s is needed, and for DVR-red said rate is 35 Mbits/s. For rewritable phase change optical recording systems such as DVR-blue, a user data rate higher than 50 Mbits/s is required.

The known medium of the phase-change type comprises a substrate carrying a stack of layers having, in succession, a first dielectric, a recording layer of the well defined phase-change compound GeTe, a second dielectric layer, and a reflective layer. Such a stack of layers can be referred to as an IPIM-structure, wherein M represents a reflective or mirror layer, I represents a first or second dielectric layer, and P represents a phase-change recording layer. A recording layer of a compound of Ge and Te has a relatively high relative reflection difference between the amorphous and crystalline phase at a laser-light wavelength in the range of 350-700 nm. Additionally a recording layer of a compound of Ge and Te has a good thermal stability due to a relatively high crystallization temperature of about 180° C. A high thermal stability results in a high archival life which generally is a requirement for storage media.

A disadvantage of the known medium is that the CET of the recording layer of a compound of Ge and Te is extremely sensitive to the composition ratio. Only a precise 50:50 ratio gives an acceptably short CET. It is a disadvantage that this sensitivity leads to poor manufacturing repeatability.

It is an object of the invention to provide an optical information medium of the kind described in the opening paragraph, which is suitable for high data rate optical recording, such as DVR-blue, having a CET-value of 50 ns or shorter and is easy to manufacture.

This object is achieved in that the recording layer comprises a compound of the formula GeₓTe₁₀₀₋ₓ,

wherein: x is a fraction of Ge in at. % and 30<x<70,

the first dielectric layer comprises a compound selected from the group consisting of oxides of Ta and Si, nitrides of Si and Al and carbides of Si, and is present in contact with the recording layer.

It has been found that these oxides, nitrides and carbides of the first dielectric layer drastically broaden the usable composition range of the compound of Ge and Te of the recording layer. The usable composition range is the range of compositions of Ge and Te with a low CET. Additionally, when using these oxides, nitrides or carbides, the CET, surprisingly, becomes much lower, e.g. a factor of approximately 2 or more, for the composition range 30<x<70. A broad usable composition range is advantageous in manufacture because the composition of the compound of Ge and Te may be varied considerably without increasing the CET. A precise 50:50 ratio, x=50, is no longer required for obtaining good results.

In an embodiment the second dielectric layer, as well as the first dielectric layer, comprises a compound selected from the group consisting of oxides of Ta and Si, nitrides of Si and Al, and carbides of Si, and is present in contact with the recording layer. This has the advantage that both sides of the recording layer are in contact with dielectric layers of oxides of Ta and Si, nitrides of Si and Al and carbides of Si, which results in an even lower CET, e.g. a factor of approximately 3, and an even broader composition range of the compound of the recording layer.

Preferrably, the first dielectric layer and the second dielectric layer comprise a compound selected from the group of Ta₂O₅ and Si₃N₄. These materials have the advantage of being easily manufacturable, and have shown to be very suitable for broadening the usable composition range and lowering the CET.

In a preferred embodiment the first dielectric layer and the second dielectric layer have a thickness of at most 15 nm. Since the thermal conductivity of Ta₂O₅ and Si₃N₄ is better than that of (ZnS)₈₀(SiO₂)₂₀, which is a frequently used material in a dielectric layer, the power sensitivity of the recording layer, having contact with the Ta₂O₅ or Si₃N₄ layer, is lower. However, the effect on the recording power sensitivity is not or hardly present when using a Ta₂O₅₋or Si₃N₄₋layer that is thinner than 15 nm.

In a more preferred embodiment the first dielectric layer and the second dielectric layer have a thickness in the range 2-10 nm. A layer in the range of 2-10 nm has no noticeable effect on the recording power sensitivity. A layer of thinner than 2 nm is difficult to manufacture reliably, because thickness control of such a thin layer is troublesome and the probability of pinholes in such a thin layer is higher.

It is preferred that 40<x<60, wherein x is the value from the formula of the compound GeₓTe₁₀₀₋ₓ of the recording layer. This range of the value of x is particularly suitable for obtaining a low CET, which is required for high data rate recording. High data rate recording requires high speed recording since the mark size on the optical recording medium is substantially determined by the recording spot size that is relatively fixed for a given laser-light wavelength and numerical aperture of the recording lens. High speed recording is to be understood to mean in this context a linear velocity of the medium relative to the laser-light beam of at least 7.2 m/s, which is six times the speed according to the Compact Disc standard. Preferably, the CET-value should be below 45 ns, necessary for a linear velocity of 9.6 m/s corresponding to eight times the CD-velocity, or even below 35 ns, necessary for a linear velocity of 14.4 m/s corresponding to twelve times the CD-velocity. The jitter of the medium should be at a low, constant level. Moreover, the medium should have a good thermal stability.

The compound of the recording layer additionally may contain O or N in an amount up to 5 at. %. Both, addition of O and N results in a shorter CET by a factor of up to 1.5. The CET-value can be drastically reduced when oxygen or nitrogen is present in the compound in small amounts of between 0.01 and 5 at. %, preferably between 1.5 and 2.0 at. %. Lower oxygen or nitrogen values than 0.01 at. % can hardly be obtained due to the process circumstances in which the recording layer is obtained, e.g. by sputtering in an inert gas atmosphere wherein an oxygen or nitrogen background pressure inevitably will be present. At an oxygen or nitrogen concentration above 5 at. %, the CET-value of the recording layer rises above 50 ns, and the jitter and the DOW cyclability are adversely affected. Also, the maximum change of amorphous and crystalline reflection during DOW becomes unacceptably small. Moreover, the recorded amorphous marks may become unstable, because of the ease of formation of oxides or nitrides, when the oxygen or nitrogen content is too high.

The reflective layer may comprise at least one of the metals selected from a group consisting of Al, Ti, Au, Ag, Cu, Rh, Pt, Pd, Ni, Co, Mn, Cr, Mo, W, Hf and Ta, including alloys thereof.

Additional dielectric layers may be present adjacent the first and/or second dielectric layers in order to protect the recording layer from humidity, to thermally insulate the recording layer from the substrate and/or reflective layer, and to optimize the optical contrast. Generally the laser-light first passes the second dielectric layer before reaching the recording layer.

In particular, a third dielectric layer may be present, i.e. adjacent the first dielectric layer and between the first dielectric layer and reflective layer, at a side remote from the recording layer. The thickness generally is between 10 and 50 nm, preferably between 15 and 35 nm. When this layer is too thin, the thermal insulation between the recording layer/first dielectric layer and a further layer, i.e. the reflective layer is adversely affected. As a result, the cooling rate of the recording layer is increased, which leads to a slow recrystallization or erasure process and a poor cyclability. The cooling rate will be decreased by increasing the thickness of the third dielectric layer.

A fourth dielectric layer may be present, i.e. adjacent the second dielectric layer, at a side remote from the recording layer.

From the viewpoint of jitter, the total thickness of the dielectric layer or neighboring dielectric layers, through which the laser-light is incident first, is preferably at least 70 nm. In view of optimal optical contrast for reading out amorphous recording marks in a crystalline environment, the thickness of this layer or these layers is set to an optimal value, above 70 nm, depending on the laser-light wavelength used and the refractive index of the dielectric layer or layers. Optionally, the outermost layer of the stack, opposite from the substrate, is screened from the environment by means of a protective cover layer of, for example, UV light-cured poly(meth)acrylate. The substrate and the cover layer may be interchanged, in which case the laser-light passes first through the substrate before entering the stack.

The CET-value is little sensitive to the thickness of the reflective layer in the range from 20 to 200 nm. But the cyclability is adversely affected when the reflective layer is thinner than 60 nm, because the cooling rate is too low. When the reflective layer is 160 nm or thicker, the cyclability deteriorates further, and the recording and the erasing power must be high because of the increased thermal conduction. Preferably the thickness of the reflective layer is between 80 and 120 nm.

The additional dielectric layers, i.e. the third and fourth dielectric layers, may consist of a mixture of ZnS and SiO₂, e.g. (ZnS)₈₀(SiO₂)₂₀.

Both the reflective layers and the dielectric layers can be provided by vapor deposition or sputtering.

When the laser-light beam is first incident through the substrate of the information medium it is at least transparent to the laser wavelength, and is made, for example, of polycarbonate, polymethyl methacrylate (PMMA), amorphous polyolefin or glass. In a typical example, the substrate is disc-shaped and has a diameter of 120 mm and a thickness of 0.1, 0.6 or 1.2 mm.

The surface of the substrate on the side of the recording stack preferably is provided with a servo track that can be scanned optically. This servo track often is a spiral-shaped groove and is formed in the substrate by means of a mould during injection molding or pressing. These grooves can be alternatively formed in a replication process in the synthetic resin of the transparent spacer layer, for example, a UV light-curable acrylate, which is separately provided on the substrate. In high-density recording such a groove has a pitch, e.g., of 0.6-0.8 μm and a width of 0.5 μm.

High-density recording and erasing can be achieved by using a short-wavelength laser, e.g. with a wavelength of 670 nm or shorter.

The phase-change recording layer can be applied to the substrate by vacuum deposition, electron beam vacuum deposition, chemical vapor deposition, ion plating or sputtering. When sputtering is used, a Ge-Te sputter target having the desired amount of oxygen or nitrogen can be applied, or use can be made of a Ge-Te target, thereby controlling the amount of oxygen or nitrogen in the sputtering gas. In practice, the concentration of oxygen or nitrogen in the sputtering gas will be between almost zero and 10% by volume. The layer as deposited is amorphous and exhibits a low reflection. In order to constitute a suitable recording layer having a high reflection, this layer must first be completely crystallized, which is commonly referred to as initialization. For this purpose, the recording layer can be heated in a furnace to a temperature above the crystallization temperature of the Ge-Te, Ge-Te-O or Ge-Te-N compound, e.g. 190° C. A synthetic resin substrate, such as polycarbonate, can alternatively be heated by a laser-light beam of sufficient power. This can be realized, e.g. in a recorder, in which case the laser-light beam scans the moving recording layer. The amorphous layer is then locally heated to the temperature required for crystallizing the layer, without the substrate being subjected to a disadvantageous heat load.

The optical information medium according to the invention will be elucidated in greater detail by means of an exemplary embodiment and with reference to the accompanying drawings, in which

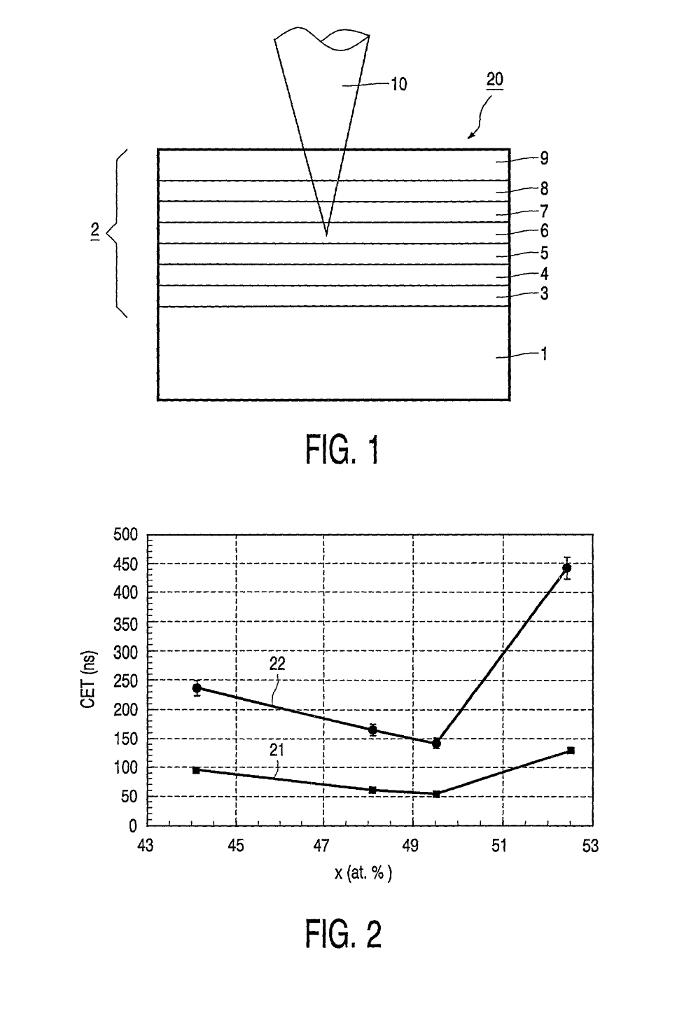

FIG. 1 shows a schematic cross-sectional view of the optical information medium in accordance with the invention. The dimensions are not drawn to scale;

FIG. 2 shows two graphs with the dependency of the complete erasure time (CET in ns) on the value of x in a GeₓTe₁₀₀₋ₓ recording layer, comparing the CET of the known medium with the CET of the medium according to the invention;

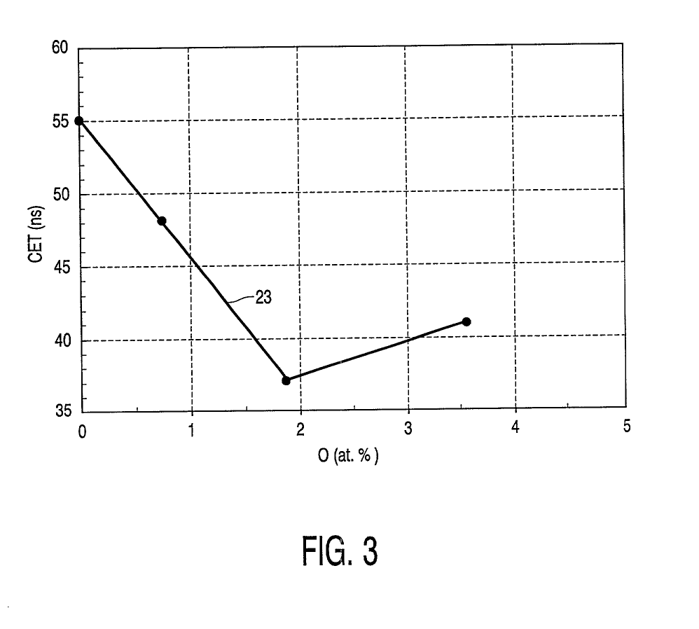

FIG. 3 shows a graph with the dependency of the complete erasure time (CET in ns) on the amount of oxygen in a Ge₄₉₋₅Te₅₀₋₅ recording layer of the medium in accordance with the invention.

Exemplary Embodiment

In FIG. 1 the information medium 20 for erasable recording by means of a laser-light beam 10 has a substrate 1. A stack 2 of layers is provided thereon. The stack 2 has a first dielectric layer 5 and a second dielectric layer 7, a recording layer 6 that is able to change between an amorphous and a crystalline state. The recording layer is arranged between the first dielectric layer 5 and the second dielectric layer 7. A reflective layer 3 is present. The recording layer 6 comprises a compound of the formula Ge_{49.5}Te_{50.5}. The compound of the recording layer 6 additionally may contain O or N in an amount up to 5 at. %. The recording layer has a thickness of 28 nm, optimized for a laser-light wavelength of 670 nm.

The first dielectric layer 5 and the second dielectric layer 7 are of Si₃N₄, and are present in contact with the recording layer 6. A good alternative for Si₃N₄ is Ta₂O₅. The first dielectric layer 5 and the second dielectric layer 7 have a thickness of 5 nm.

The reflective layer 3 comprises Al with a thickness of 100 nm.

A third dielectric layer 4 and a fourth dielectric layer 8 of, e.g., (ZnS)₈₀(SiO₂)₂₀ are present, respectively, adjacent the first dielectric layer 5 and the second dielectric layer 7. The thickness of the third dielectric layer is 20 nm and the thickness of the fourth dielectric layer is 90 nm. In such a stack, at a laser-light wavelength of 670 nm, the amorphous reflection Rₐ is 3.8% and the crystalline reflection R_{c} is 36.5%.

Substrate 1 is a polycarbonate disc-shaped substrate having a diameter of 120 mm and a thickness of 0.6 mm.

A cover layer 9, made of e.g. a UV cured resin Daicure SD645 with a thickness of 100 μm, is present adjacent the fourth dielectric layer 8.

When a laser-light wavelength of 405 nm is used, the optimal thickness of the recording layer 6 is 15 nm and the third and fourth dielectric layer 4, 8 have thicknesses of 20 and 135 nm respectively. The other layers of the stack 2 and the substrate 1 remain unchanged. In such a stack 2, at a laser-light wavelength of 405 nm, the amorphous reflection Rₐ is 0.8% and the crystalline reflection R_{c} is 22.9%.

FIG. 2 shows a graph 21 of the dependency of the complete erasure time (CET) on the value of x in a GeₓTe₁₀₀₋ₓ recording layer, in contact with a first and a second dielectric layer of Si₃N₄ in an II'PI'IM stack according to FIG.1, but without the addition of oxygen to the recording layer 6. For comparison another graph 22 is shown when the materials of the first and the second dielectric layer are replaced by the standard material (ZnS)₈₀(SiO₂)₂₀. It is concluded that in the medium according to the invention using first and second dielectric layers according to the invention a reduction of the CET of approximately a factor of 3 is achieved.

FIG. 3 shows a graph 23 of the effect on the CET (in ns) of the presence of O in the compound Ge_{49.5}Te_{50.5}of the recording layer 6 in an amount up to 3.5 at. % in a stack according to FIG. 1. Similar effects are obtained with addition of nitrogen. Thus, in an optimal embodiment the recording layer 6 is of the formula Ge_{49.5}Te_{50.5}, in which 1.87 at. % oxygen is present.

According to the invention, a rewritable phase-change optical information medium is provided, such as DVR-blue, with a recording layer of a Ge-Te compound in contact with at least one dielectric layer comprising a compound of oxides of Ta and Si, nitrides of Si and Al or carbides of Si, with a broad usable composition range, and therefore easy to manufacture, having low complete erasure time (CET) values, and which is suitable for direct overwrite and high data rate recording, and exhibits a good cyclability and a low jitter at a linear velocity of 7.2 m/s or more. Presence of oxygen or nitrogen in the recording layer gives an extra decrease of the CET to values of below 45 ns.

1. An optical information medium (20) for erasable recording by means of a laser-light beam (10) having a laser-light wavelength, said medium (20) having a substrate (1) and a stack (2) of layers provided thereon, the stack (2) comprising a first dielectric layer (5) and a second dielectric layer (7), a recording layer (6) that is able to change between an amorphous and a crystalline state, arranged between the first dielectric layer (5) and the second dielectric layer (7), and a reflective layer (3), characterized in that
the recording layer (6) comprises a compound of the formula GeₓTe₁₀₀₋ₓ,
wherein: x is a fraction of Ge in at % and 30<x<70,
the first dielectric layer (5) comprises a compound selected from the group consisting of oxides of Ta and Si, nitrides of Si and Al and carbides of Si, and is present in contact with the recording layer (6).

2. An optical information medium (20) as claimed in claim 1, characterized in that the second dielectric layer (7) comprises a compound selected from the group consisting of oxides of Ta and Si, nitrides of Si and Al, and carbides of Si, and is present in contact with the recording layer (6).

3. An optical information medium (20) as claimed in claim 2, characterized in that the first dielectric layer (5) comprises a compound selected from the group of Ta₂O₅ and Si₃N₄ and the second dielectric layer (7) comprises a compound selected from the group of Ta₂O₅ and Si₃N₄.

4. An optical information medium (20) as claimed in claim 3, characterized in that the first dielectric layer (5) and the second dielectric layer (7) have a thickness of at most 15 nm.

5. An optical information medium (20) as claimed in claim 4, characterized in that the first dielectric layer (5) and the second dielectric layer (7) have a thickness in the range 2-10 nm.

6. An optical information medium (20) as claimed in claim 1, characterized in that 40<x<60.

7. An optical information medium (20) as claimed in anyone of claims 1-6, characterized in that the compound of the recording layer (6) additionally contains O in an amount up to 5 at. %.

8. An optical information medium (20) as claimed in anyone of claims 1-6, characterized in that the compound of the recording layer (6) additionally contains N in an amount up to 5 at. %.

9. An optical information medium (20) as claimed in claim 1, characterized in that the reflective layer (3) comprises at least one of the metals selected from a group consisting of Al, Ti, Au, Ag, Cu, Rh, Pt, Pd, Ni, Co, Mn, Cr, Mo, W, Hf and Ta, including alloys thereof.

10. The use of an optical information medium (20) for high-speed recording, in which the relative velocity between the laser-light beam and the medium is at least 7.2 m/s, characterized in that an optical information medium (20) of one of the preceding claims is used.
